(19) United States
(12) Patent Application Publication
(10) Pub. No.: US 2023/0069101 A1
(43) Pub. Date: Mar. 2, 2023

(54) Rotary Crushing Device and Rotary Crushing Method

(71) Applicant: JDC Corporation, Minato-Ku Tokyo (JP)

(72) Inventors: Akimitsu Ebihara, Tokyo (JP); Hiroshi Obata, Tokyo (JP); Hidetoshi Morimoto, Tokyo (JP)

(21) Appl. No.: 17/793,358

(22) PCT Filed: Dec. 18, 2020
(86) PCT No.: PCT/JP2020/047400

§ 371 Date: Jul. 15, 2022

Related U.S. Application Data
(60) Provisional application No. 62/971,287, filed on Feb. 7, 2020.

(51) Int. Cl. B02C 13/16; B02C 13/286

(52) U.S. Cl. CPC B02C 13/16; B02C 13/286; B02C 2013/28609

(57) ABSTRACT

To enable an impact applying member to efficiently crush an object to be crushed, a rotary crushing apparatus includes an impact applying member that is connected to a rotating shaft and crushes a processing object by means of rotation of the rotating shaft. The apparatus also includes a feeding device that feeds the processing object to the impact applying member in such a way that an axis direction of conveyance of the processing object is substantially identical to an axis direction of rotation of the impact applying member.

### TECHNICAL FIELD

The present invention relates to a rotary crushing device or apparatus and a rotary crushing method.

### BACKGROUND

There are known a rotary crushing (mixing) method for improving and effectively using soil displaced by construction, and the like and an apparatus to be used for the method (see, for example, Patent Publication No. WO 2019/016859 A).

The rotary crushing (mixing) method uses a processing device equipped with an impact applying member (impact member) that rotates at high speed in a cylindrical container. In the rotary crushing (mixing) method, soil displaced by construction is fed into the container and crushed into fine-grained soil by means of the impact force of the impact member. Thus, the rotary crushing (mixing) method has the effect of smoothing the particle size distribution of material. In addition, it is possible to adjust the properties, strength, and the like of improved soil by mixing add-in material in soil displaced by construction, as necessary. Examples of the add-in material include lime-based solidification materials such as quicklime and slaked lime, cement-based solidification materials such as ordinary cement and blast furnace cement, and soil improving materials made from high-polymer materials. Note that soil displaced by construction is conveyed to the inlet of a rotary crushing apparatus by a conveyor belt.

### SUMMARY

Proposals have been made for impact members that crush soil displaced by construction in terms of the shape, number, and the like of impact members for efficiently crushing soil displaced by construction. However, not many proposals have been made on how to feed soil displaced by construction to impact members, and there has been room for improvement.

Therefore, an object of the present invention is to provide a rotary crushing apparatus and a rotary crushing method that enable an impact applying member to efficiently crush an object to be crushed.

A rotary crushing apparatus according to a first implementation of the invention includes an impact applying member, also referred to as an impactor, that is connected to a rotating and crushes a processing object by means of rotation of the rotating shaft. The apparatus also includes a feeding device, also referred to as a feeder, that feeds the processing object to the impact applying member in such a way that an axis direction of conveyance of the processing object is substantially identical to an axis direction of rotation of the impact applying member.

A rotary crushing method according to a second implementation of the invention includes a step of rotating an impact applying member by means of rotation of a rotating shaft, the impact applying member being capable of crushing a processing object; and a step of feeding the processing object to the impact applying member in such a way that an axis direction of conveyance of the processing object is substantially identical to an axis direction of rotation of the impact applying member.

In the rotary crushing apparatus according to the implementations of the teachings herein, the axis direction of conveyance of a processing object is substantially identical to the axis direction of rotation of the impact applying member. Therefore, the impact applying member the impact applying member can efficiently crush the processing object.

### BRIEF DESCRIPTION OF THE DRAWINGS

FIG. 1 is a diagram schematically showing a configuration of a rotary crushing apparatus according to an embodiment.

FIG. 2 is a diagram showing a scraping rod provided in a rotating drum.

FIG. 3A is a diagram schematically showing placement of a conveyor belt according to the embodiment of FIG. 1 viewed from above. FIG. 3B is a diagram showing placement of a conveyor belt according to a comparative example.

FIG. 4A is diagram of a top view describing the center of percussion of an impact member. FIG. 4B is a diagram of a side view thereof.

FIG. 5A is a diagram showing a first comparative example of a rotation mechanism. FIG. 5B is a diagram showing a second comparative example of the rotation mechanism. FIG. 5C is a diagram showing the amount of deflection of a rotating shaft in the first comparative example. FIG. 5D is a diagram showing the amount of deflection of a rotating shaft in the second comparative example.

FIG. 6A is a diagram showing a third comparative example of the rotation mechanism. FIG. 6B is a diagram showing a rotation mechanism according to the embodiment. FIG. 6C is a diagram showing the amount of deflection of a rotating shaft in the third comparative example. FIG. 6D is a diagram showing the amount of deflection of a rotating shaft in the rotation mechanism according to the embodiment.

FIG. 7A and FIG. 7B are diagrams of a first modified example of the impact member of FIG. 4A.

FIG. 8 is a diagram describing the length of the impact member according to a second modified example.

### DETAILED DESCRIPTION

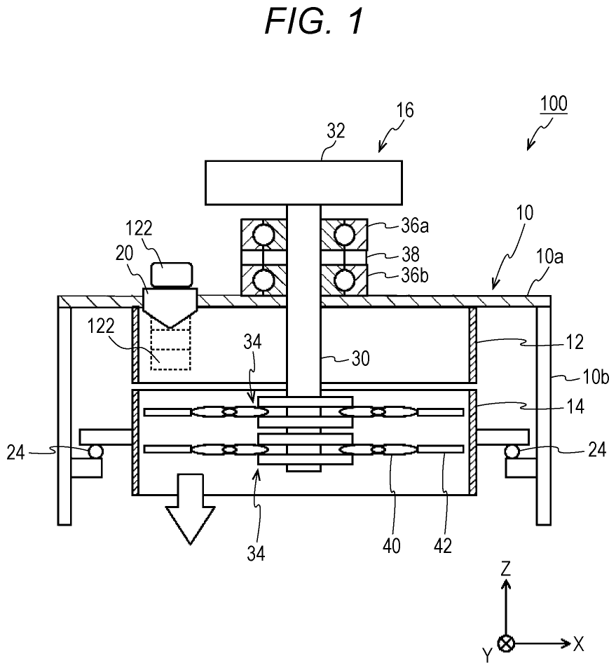

Hereinafter, a rotary crushing apparatus according to an embodiment will be described in detail initially with reference to FIGS. 1 to 6.

FIG. 1 schematically shows the configuration of a rotary crushing apparatus 100 according to the embodiment. A section of a part of the rotary crushing apparatus 100 is shown in FIG. 1 for convenience of illustration. Furthermore, for convenience of description, a vertical direction is defined as a Z-axis direction, and two axis directions orthogonal to each other in a horizontal plane are defined as an X-axis direction and a Y-axis direction in FIG. 1.

The rotary crushing apparatus 100 of the present embodiment is an apparatus to be used for improving and effectively using raw material soil such as soil displaced by construction. The rotary crushing apparatus 100 crushes raw material soil into fine-grained soil to smooth the particle size distribution of the raw material soil. Furthermore, add-in material (for example, lime-based solidification materials such as quicklime and slaked lime, cement-based solidification materials such as ordinary cement and blast furnace cement, soil improving materials made from high-polymer materials, or natural fiber) is also fed into the rotary crushing apparatus 100 as necessary. When add-in material is added, the rotary crushing apparatus 100 mixes the raw material soil and the add-in material to obtain improved soil. Thus, the rotary crushing apparatus 100 adjusts the properties, strength, and the like of the improved soil.

As shown in FIG. 1, the rotary crushing apparatus 100 includes a gantry 10, a stationary drum 12, a rotating drum 14, a rotation mechanism 16, a conveyor belt 122, and the like.

The gantry 10 holds each part of the rotary crushing apparatus 100 and includes a top plate 10a and legs 10b. The top plate 10a is, for example, an iron plate-like member that functions as a lid for closing the upper opening of the stationary drum 12 fixed to a lower surface (a surface located on the negative side of the Z-axis). Provided is an inlet member 20 through which raw material soil and add-in material are fed into the stationary drum 12. Note that the raw material soil is conveyed to the inlet member 20 by the conveyor belt 122.

The stationary drum 12 is a cylindrical container and is fixed to the lower surface (the surface located on the negative side of the Z-axis) of the top plate 10a. Raw material soil and add-in material are fed into the stationary drum 12 through the inlet member 20 and are guided into the rotating drum 14 provided on the lower side (the negative side of the Z-axis) of the stationary drum 12.

The rotating drum 14 is a cylindrical container and is rotated (rotated on its axis) around the central axis (Z-axis) of the cylinder by a rotating drum drive motor (not shown). The rotating drum 14 is supported by the gantry 10 via a plurality of support rollers 24. Thus, when being subjected to the turning force of the rotating drum drive motor 154, the rotating drum 14 rotates smoothly. Note that the rotation direction of the rotating drum 14 may be identical to or opposite to the rotation direction of an impact member 34.

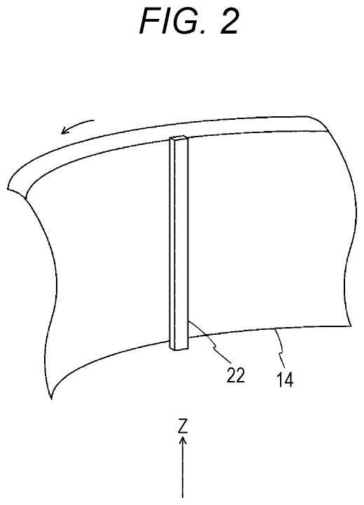

As shown in FIG. 2, one or more scraping rods (scrapers) 22 are provided in the rotating drum 14 (not shown in FIG. 1). The scraping rod 22 is in contact with the inner peripheral surface of the rotating drum 14 and is fixed to the stationary drum 12. Therefore, as the rotating drum 14 rotates, the scraping rod 22 moves relatively along the inner peripheral surface of the rotating drum 14. As a result, even when the raw material soil or the add-in material adheres to the inner peripheral surface of the rotating drum 14, the raw material soil or the add-in material is scraped off by the scraping rod 22 as the rotating drum 14 rotates. That is, the scraping rod 22 and the rotating drum 14 that moves relative to the scraping rod 22 implement a function as a scraping part that scrapes off the raw material soil or add-in material adhering to the inner peripheral surface of the rotating drum 14.

Returning to FIG. 1, the rotation mechanism 16 includes a rotating shaft 30, a pulley 32, and two impact members 34. The rotating shaft 30 is disposed in the center of the stationary drum 12 and the rotating drum 14, and the rotating shaft 30 extends in the vertical direction (Z-axis direction). The pulley 32 is provided at the upper end of the rotating shaft 30. The impact members 34 are vertically arranged in two tiers in the vicinity of the lower end of the rotating shaft 30. Note that the impact member 34 includes a chain 40 and a thick plate 42 (details will be described below).

The rotating shaft 30 is a columnar member penetrating the top plate 10a of the gantry 10, and the rotating shaft 30 is rotatably held by the top plate 10a via two ball bearings 36a and 36b provided on the upper surface side of the top plate 10a. A spacer 38 is provided between the two ball bearings 36a and 36b, so that there is a predetermined distance between the ball bearings 36a and 36b. The lower end of the rotating shaft 30 is a free end located inside the rotating drum 14. That is, the rotating shaft 30 is cantilevered.

The pulley 32 is connected to a motor (not shown) via a belt. When the motor (not shown) rotates, the pulley 32 and the rotating shaft 30 rotate.

The conveyor belt 122 conveys raw material soil to the inlet member 20. In the present embodiment, the conveyor belt 122 conveys raw material soil in the Y direction and the Z direction. The conveyor belt 122 conveys the raw material soil from the back side of the drawing to the front side of the drawing in the Y direction. Furthermore, the conveyor belt 122 conveys the raw material soil from the lower side to the upper side in the Z direction. Note that add-in material is conveyed to the inlet member 20 by a conveyance mechanism (not shown).

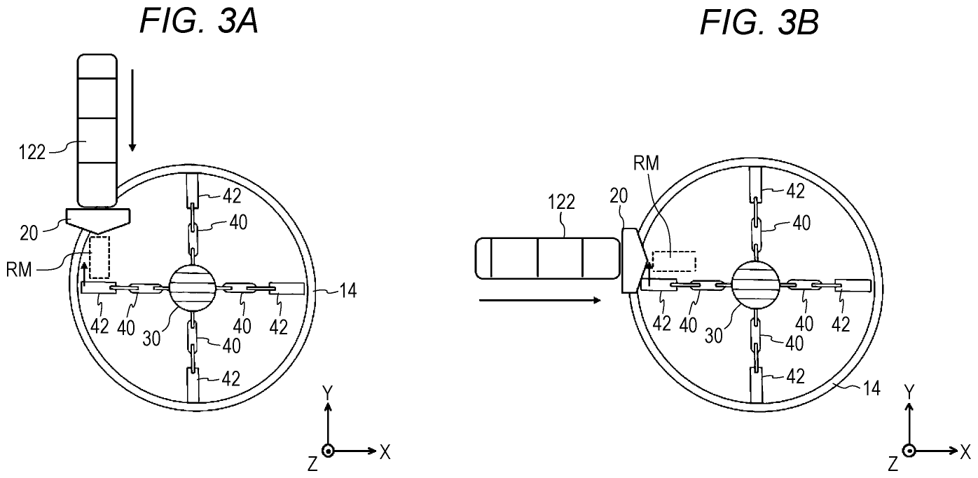

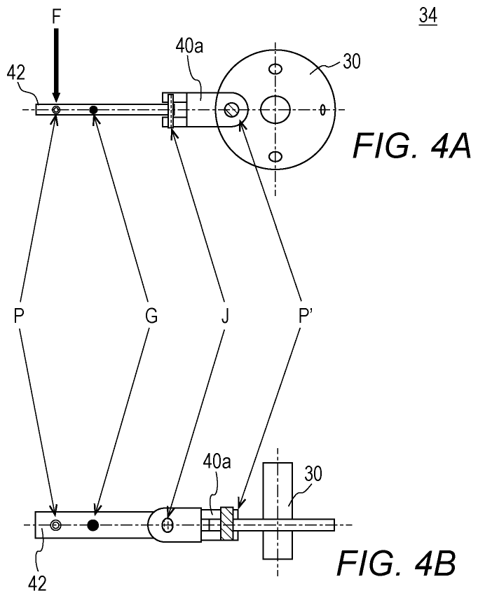

FIG. 3A shows an arrangement of the inlet member 20 and the conveyor belt 122 in the present embodiment of the rotary crushing apparatus 100 viewed from above. FIG. 3B shows arrangement of the inlet member 20 and the conveyor belt 122 in a comparative example. Note that although these figures show the impact member 34 including the chain 40 and the thick plate 42, the impact member 34 may include a universal joint 40a (see FIG. 4A) and the thick plate 42. Thus, the impact member 34 can be configured in various ways.

As described above, the conveyor belt 122 of the present embodiment conveys raw material soil in the Y direction and the Z direction, while the conveyor belt 122 of the comparative example conveys raw material soil in the X direction and the Z direction. When raw material soil is conveyed with a conveyance component in the Y direction as in the present embodiment, the raw material soil that falls from the inlet member 20 toward the impact member 34 is spread in the Y direction, as represented by RM in FIG. 3A. Then, the fallen material soil is crushed by the thick plate 42 of the impact member 34, the thick plate 42 being made of steel.

Here, when crushing the raw material soil, the thick plate 42 has a movement component in the Y-axis direction as a rotational component due to rotation of the rotating shaft 30 (see an arrow in FIG. 3A). Therefore, the axis direction of conveyance of the conveyor belt 122 of the present embodiment may be substantially identical to the rotation axis component of the impact member 34. Note that depending on the way of placing the conveyor belt 122 and the rotation direction of the impact member 34, the conveyance direction (Y direction) of the conveyor belt 122 may be identical to or opposite to the rotational component of the impact member 34 in the Y direction. In either case, the raw material soil can be efficiently crushed by the thick plate 42 in the present embodiment. Note that in the present embodiment, the raw material soil just needs to be mainly crushed by the thick plate 42 and accordingly, the raw material soil may also be crushed by the chain 40.

Meanwhile, when raw material soil is conveyed with a conveyance component in the X direction as in the comparative example, the raw material soil that falls from the inlet member 20 toward the impact member 34 is spread in the X direction, as represented by RM in FIG. 3B. The fallen material soil is crushed by the chain 40 and the thick plate 42 of the impact member 34. If the raw material soil is crushed by the chain 40, the chain 40 may be damaged. For example, the inner circumference of the chain may be scraped and the distance between the chain 40 and the chain 40 may be increased, so that the impact member 34 may be stretched in the X direction when the impact member 34 is rotated. As a result, a failure may be caused in which the tip of the thick plate 42 interferes with the inner wall of the rotating drum 14. Troublesome maintenance such as replacement of the chain 40 is necessary for preventing such a failure.

In the present embodiment, the inlet member 20 and the conveyor belt 122 are arranged in such a way that the raw material soil is crushed by the center of percussion of the impact member 34. FIG. 4A is a top view of the impact member 34. FIG. 4B is a side view of the impact member 34. Hereinafter, description of the center of percussion of the impact member 34 will be continued with reference to FIGS. 4A and 4B. Note that FIGS. 4A and 4B describe the impact member 34 based on a simple model in which the impact member 34 includes the universal joint 40a and the thick plate 42. Furthermore, during the rotation of the impact member 34, the universal joint 40a and the thick plate 42 can be regarded as an integrated rigid body with an articulated structure. The universal joint 40a has the effect of causing a rotation axis J to ease a force in a direction perpendicular to an impulsive force F. In this respect, the function of the universal joint 40a is the same as that of the chain 40.

The symbol “G” denotes the center of gravity of the impact member 34, which is a rigid body. The symbol “P” denotes the foot of a perpendicular from the center of gravity to the line of action of the impulsive force F. The symbol “M” denotes the mass of the impact member 34. The symbol “h” denotes the distance between the line of action of the impulsive force F and the center of gravity G. When the impact member 34 makes a rotary motion, there is a rest point serving as the center of rotation. The center of rotation is denoted by the symbol “F”, and is located on the opposite side of the point P with respect to the center of gravity G on a straight line joining the center of gravity G and the point P. The symbol “h′” denotes the distance from the center of gravity G. Furthermore, the symbol “I” denotes the moment of inertia of the impact member 34. Then, equation (1) below holds.

hh′=I/M (1)

The point P, which is the foot of the perpendicular from the center of gravity G to the line of action of the impulsive force F, is the center of percussion.

As described above, the center of percussion of the impact member 34 is located on the tip side (opposite side of the rotating shaft 30) with respect to the center of gravity of the impact member 34. Therefore, in the present embodiment, arrangement of the inlet member 20 and the conveyor belt 122 is determined in such a way that the raw material soil can be crushed on the tip side with respect to the center of gravity of the impact member 34 (i.e., the processing object is fed in such way as to put the processing object in a position of the center of percussion).

The present inventors detected a load change of the motor (not shown) when the raw material soil was crushed at various points on the impact member 34. As a result, the present inventors have found that there was substantially no load change of the motor (not shown) when the raw material soil was crushed at the position of the center of percussion (tip side of the thick plate 42) of the impact member 34, while when the raw material soil was crushed at a position other than the position of the center of percussion of the impact member 34, there was a larger load change of the motor (not shown) than in the case of crushing the raw material soil at the position of the center of percussion. Furthermore, the present inventors have found that there was also substantially no load change of the motor (not shown) in the case of crushing the raw material soil having a shape symmetrical about the position of the center of percussion of the impact member 34. This means that it is possible to reduce the power consumption of the motor (not shown) by crushing the raw material soil at the position of the center of percussion of the impact member 34 or crushing the raw material soil having a shape symmetrical about the position of the center of percussion.

In addition, the present inventors simulated reaction force acting on the thick plate 42 when the raw material soil was crushed at various positions on the thick plate 42. The result is that the reaction force in the case of crushing the raw material soil at the position of the center of percussion (the tip side of the thick plate 42) of the impact member 34 is smaller than the reaction force in the case of crushing the raw material soil at a position other than the position of the center of percussion of the impact member 34. Moreover, when the raw material soil having a shape symmetrical about the position of the center of percussion (the tip side of the thick plate 42) of the impact member 34 was crushed, the result is that the reaction force was small at the time of crushing the raw material soil.

This means that it is possible to reduce abrasion or the like of the thick plate 42 by crushing the raw material soil at the position of the center of percussion (the tip side of the thick plate 42) of the impact member 34, or by crushing the raw material soil having a shape symmetrical about the position of the center of percussion. In this way, the frequency of replacement of the thick plate 42 can be reduced.

Returning to FIG. 3A, each of the impact members 34 arranged in two tiers includes a plurality of (four in FIG. 3A) metal chains 40. The thick plate 42, which is steel, is provided at the tip of each chain 40. The chains 40 are provided around the rotating shaft 30 at regular intervals.

The impact member 34 is connected to the rotating shaft 30 and is centrifugally rotated by rotation of the rotating shaft 30. As a result, the thick plate 42 moves at high speed near the inner peripheral surface of the rotating drum 14 to crush raw material soil or mix the raw material soil and add-in material. Therefore, the rotary crushing apparatus 100 can also be called a rotary crushing and mixing device. Note that the number of the chains 40 and the thick plates 42 of the impact member 34 can be adjusted according to the type and properties of raw material soil, a processing amount, the type and amount of add-in material, the intended quality of improved soil, and the like.

According to the rotary crushing apparatus 100 of the present embodiment, raw material soil and add-in material fed into the stationary drum 12 through the inlet member 20 are crushed and mixed by the impact member 34 in the rotating drum 14. The mixed material is discharged below from the rotating drum 14.

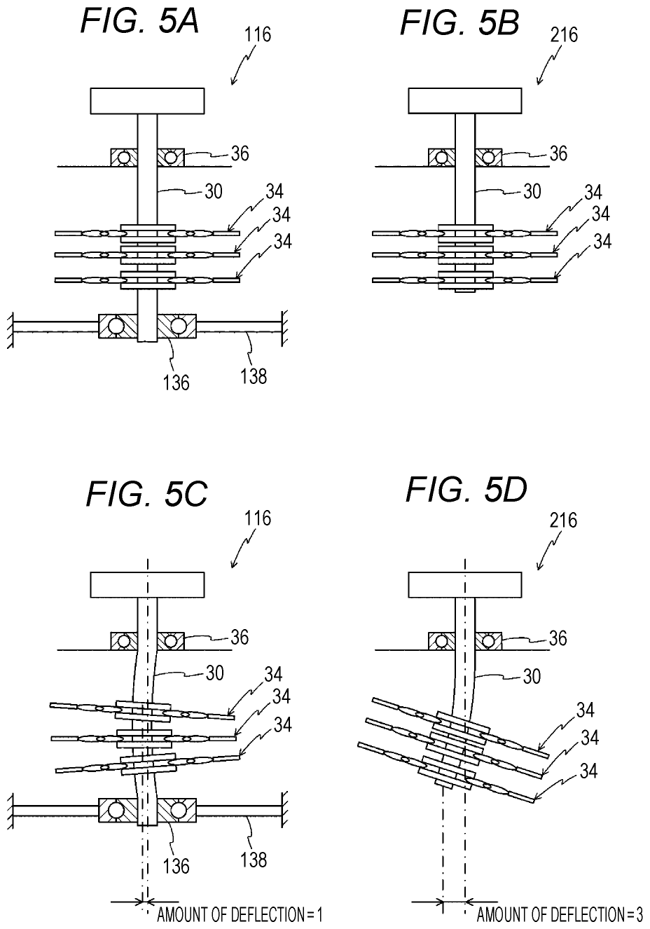

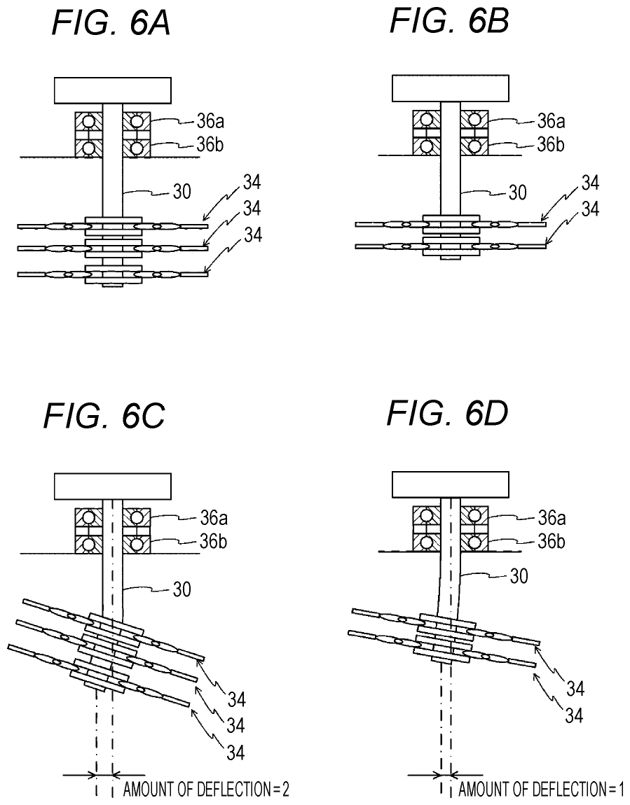

Next, the reason why the structure as shown in FIG. 1 (the structure in which the lower end of the rotating shaft 30 is a free end) can be adopted as the rotation mechanism 16 will be described with reference to FIGS. 5A-5D and 6A-6D.

FIG. 5A shows a rotation mechanism 116 according to a first comparative example.

In the first comparative example, the rotating shaft 30 is rotatably held by a single ball bearing 36 in the vicinity of the upper end. Furthermore, in the first comparative example, the rotating shaft 30 is rotatably held in the vicinity of the lower end via a ball bearing 136. Note that the ball bearing 136 is held by a support rod 138 fixed to the gantry 10. Furthermore, in the first comparative example, the impact members 34 are provided in three tiers.

The amount of deflection of the rotating shaft 30 at the time of rotating the rotating shaft 30 was simulated in the first comparative example. The result of simulation shows that the amount of deflection is small as shown in FIG. 5C, which is within a permissible range. It is considered that the amount of deflection is within the permissible range because the rotating shaft 30 is held at points in the vicinity of both ends. In the following, for convenience of description, the amount of deflection of the rotating shaft 30 in the first comparative example will be expressed as “1”.

FIG. 5B shows a rotation mechanism 216 according to a second comparative example.

The rotation mechanism 216 of the second comparative example is an example of a rotation mechanism in which the lower end of the rotating shaft 30 of the first comparative example is formed as a free end so as to shorten the rotating shaft 30. The amount of deflection of the rotating shaft 30 at the time of rotating the rotating shaft 30 was simulated in the second comparative example. The result of simulation shows that the amount of deflection is “3” as shown in FIG. 5D, which is outside the permissible range.

With reference to these simulation results, the present inventors studied a configuration (third comparative example) as shown in FIG. 6A. In the third comparative example, the ball bearing 36 of the second comparative example has been replaced with the two ball bearings 36a and 36b, and there is a predetermined distance between the ball bearings 36a and 36b. In the third comparative example, the result of simulation shows that the amount of deflection of the rotating shaft 30 during rotation is “2” as shown in FIG. 6C.

Furthermore, the present inventors have omitted one of the impact members 34 arranged in three tiers in the third comparative example to obtain the impact members 34 arranged in two tiers as shown in FIG. 6B. In the case of adopting this configuration, the result of simulation shows that because the length of the rotating shaft becomes shorter, the amount of deflection of the rotating shaft 30 during rotation is “1” as shown in FIG. 6D. This amount of deflection is within the permissible range as in the first comparative example.

Thus, as a result of the comparative study as described above, the present inventors have found that it is also possible to reduce the amount of deflection by adopting the configuration as shown in FIG. 6B to form the rotating shaft 30 as a free end. Note that the present inventors have improved the shape and the like of the thick plate 42 of the impact member 34 so that crushing/mixing performance does not deteriorate as a result of reducing the number of the impact members 34 arranged in tiers from three to two, and the present inventors have maintained crushing/mixing performance equivalent to that in the case of the impact members 34 arranged in three tiers.

Furthermore, to reduce the amount of deflection of the rotating shaft 30, the present inventors have determined the distance between the ball bearings 36a and 36b according to the diameter of the rotating shaft 30. That is, the distance between the ball bearings 36a and 36b has been increased for the rotating shaft 30 with a smaller diameter to reduce the amount of deflection. In addition, angular ball bearings have been adopted as the ball bearings 36a and 36b to improve the rotation accuracy and rigidity of the rotating shaft 30. Furthermore, the length of the rotating shaft 30 has been determined in such a way that when the impact member 34 is centrifugally rotated, the amount of deflection of the rotating shaft 30 is within the permissible range of stress to be applied to the ball bearings 36a and 36b supporting the rotating shaft 30. As an example, the amount of deflection of the rotating shaft 30 has been set to 1/800 to 1/3,000 of the length of the rotating shaft 30.

In the present embodiment, it is possible to shorten the length of the rotating shaft 30 while keeping the crushing/mixing performance and the amount of deflection of the rotating shaft 30 at low levels, by adopting the rotation mechanism 16 as described above. As a result, the height dimension of the rotary crushing apparatus 100 can be reduced. Furthermore, it is not necessary to provide a configuration for holding the lower end of the rotating shaft 30 (the support rod 138 or the ball bearing 136 as in the first comparative example of FIG. 5A). As a result, the structure is simplified to reduce the number of places in the rotary crushing apparatus 100 to which the crushed/mixed raw material soil and add-in material adhere. Thus, it is possible to reduce the number of times cleaning of the inside of the rotary crushing apparatus 100 is performed and improve maintainability. Moreover, because the number of parts is reduced, the manufacturing cost of the apparatus can be reduced. Furthermore, the weight of the rotary crushing apparatus 100 can also be reduced.

Note that the rotary crushing apparatus 100 of the present embodiment can be applied not only to a self-propelled processing system but also to a plant-type processing system to be installed on site, an on-truck type processing system to be installed on the loading platform of a truck, and the like. In the case of the plant-type processing system, in which provided is a conveyor belt that conveys raw material soil to the position of the inlet member 20, it is possible to shorten the length of the conveyor belt because the height of the rotary crushing apparatus 100 is low. As a result, the entire processing system can be miniaturized, and an area exclusive to a plant can be reduced, so that the field layout plan of the processing system is facilitated.

As described in detail above, the rotating shaft 30 is provided in such a way as to penetrate the top plate 10a, and the rotating shaft 30 is rotatably held via the ball bearings 36a and 36b provided in the vicinity of the top plate 10a. In addition, the lower end of the rotating shaft 30 is a free end. As a result, the length of the rotating shaft 30 can be shortened, so that the rotary crushing apparatus 100 can be miniaturized. Furthermore, it is not necessary to provide a ball bearing or the like that rotatably holds the lower end of the rotating shaft 30. Therefore, the structure is simplified, and maintenance is facilitated.

Furthermore, in the present embodiment, the ball bearings 36a and 36b are provided on the upper side of the top plate 10a. Accordingly, maintainability can be improved as compared with the case where the ball bearings 36a and 36b are provided on the lower side of the top plate 10a. In addition, because raw material soil and add-in material do not come into contact with the ball bearings 36a and 36b, the raw material soil and the add-in material do not adhere to the ball bearings 36a and 36b. It is thus possible to extend the life of the ball bearings 36a and 36b. Note that it is desirable to provide a cover around the ball bearings 36a and 36b to prevent foreign matter from adhering to the ball bearings 36a and 36b.

Furthermore, in the present embodiment, the rotating shaft 30 is rotatably held by the two ball bearings 36a and 36b. Therefore, the amount of deflection of the rotating shaft 30 can be reduced as compared with the case where the rotating shaft 30 is rotatably held by a single ball bearing (the second comparative example shown in FIGS. 5B and 5D).

Furthermore, in the present embodiment, the distance between the ball bearings 36a and 36b is determined according to the diameter of the rotating shaft 30. That is, the distance between the ball bearings 36a and 36b has been increased for the rotating shaft 30 with a smaller diameter to reduce the amount of deflection. As a result, the distance between the ball bearings 36a and 36b can be appropriately set according to the diameter of the rotating shaft 30.

Furthermore, in the present embodiment, angular ball bearings are used as the ball bearings 36a and 36b. Accordingly, the ball bearings 36a and 36b can bear a load in a thrust direction of the rotating shaft 30 or the impact member 34, and the ball bearings 36a and 36b can also bear a load in a radial direction when the impact member 34 is rotated. Therefore, it is possible to reduce deflection of the rotating shaft due to rotation of the impact member 34.

Note that in the above embodiment, the case where the rotating shaft 30 is held by the two ball bearings in the vicinity of the upper end of the rotating shaft 30 has been described. The present invention is not limited thereto, and the rotating shaft 30 may be held by three or more ball bearings in the vicinity of the upper end of the rotating shaft 30.

Note that in the above embodiment, the case where the rotating shaft 30 is provided with the impact members 34 arranged in two tiers has been described, The present invention is not limited thereto, and the rotating shaft 30 may be provided with the single impact member 34 or the impact members 34 arranged in three or more tiers. Furthermore, the rotating shaft 30 may be held by a single ball bearing or three or more ball bearings provided on the upper side of the top plate 10a. Furthermore, at least either of the ball bearings 36a and 36b may be disposed on the lower side of the top plate 10a.

The embodiment described above is an example of a preferred embodiment of the present invention. However, the present invention is not limited thereto, and an object to be crushed by the impact member 34 is not limited to raw material soil. For example, the object to be crushed by the impact member 34 may be gravel, broken stone, or the like, or may be raw material soil mixed with gravel, broken stone, or the like. Furthermore, addition of add-in material may be omitted. Moreover, the rotating shaft 30 may be supported at both ends instead of being cantilevered. As described above, various modifications can be made without departing from the gist of the present invention.

### FIRST MODIFIED EXAMPLE

In the above embodiment, a raw material soil feed range (RM in FIG. 3A) is set in such a way that the axis direction of conveyance of the conveyor belt 122 is substantially identical to the rotation axis component of the impact member 34 at the time of collision between the impact member 34 and raw material soil (i.e., when the impact member 34 and raw material soil collide). Meanwhile, in the present modified example, that is, a first modified example, the location of the raw material soil feed range RM is set based on a viewpoint different from the above embodiment.

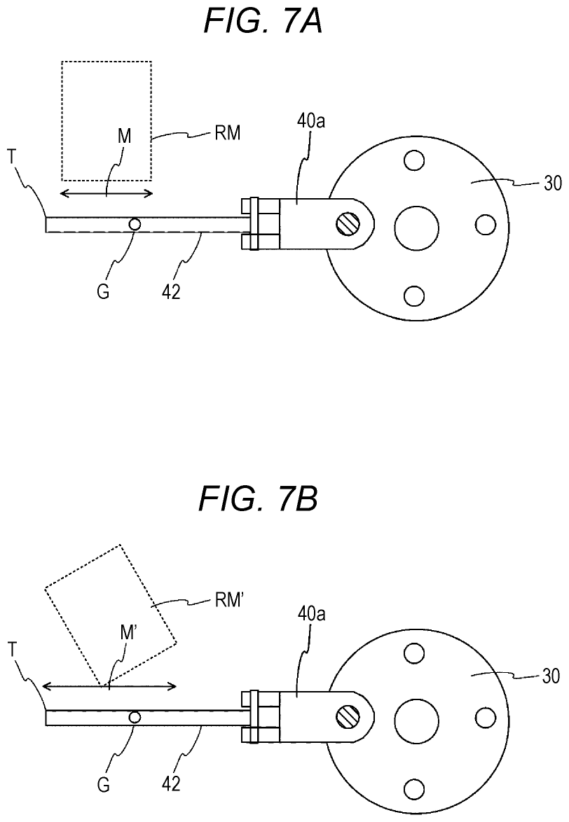

FIG. 7A shows a model (a model in which an impact member 34 includes a universal joint 40a and a thick plate 42) viewed from above which is the same as the model of the above embodiment described in FIG. 4A. In the present modified example, that is, the first modified example, the positions of a conveyor belt 122 and an inlet member 20 for feeding raw material soil are set in such a way that when the impact member 34 rotates and passes through a raw material soil feed range RM, the center M of the width of the raw material soil feed range RM passes through between the center of gravity G of the impact member 34 and a tip T located on a side opposite to a rotating shaft 30, as shown in FIG. 7A.

Note that even in the case where the raw material soil feed range is positioned as shown in FIG. 7B (the case where the axis direction of conveyance of the conveyor belt 122 is significantly different from the rotation axis component of the impact member 34 at the time of collision between the impact member 34 and raw material soil), the positions of the conveyor belt 122 and the inlet member 20 for feeding raw material soil just need to be set in such a way that the center M′ of the width of a raw material soil feed range RM′ passes through between the center of gravity G of the impact member 34 and the tip T located on the side opposite to the rotating shaft 30, as shown in FIG. 7B.

In this manner, most of raw material soil can be applied to the thick plate 42 of the impact member 34, so that it is possible to prevent a chain 40 from being hit and damaged by the raw material soil.

### SECOND MODIFIED EXAMPLE

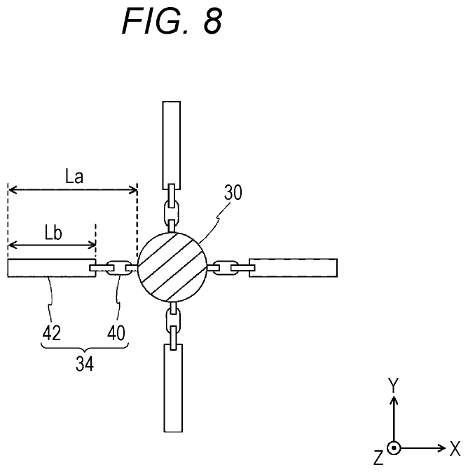

The present inventors studied the ratio of the length Lb of a thick plate 42 to the total length La of an impact member 34 for the impact member 34 shown in FIG. 8.

This study was conducted in consideration of the possibility of contact between raw material soil and a chain 40 and the weight, cost, and maintainability of the impact member 34. As a result, it was found that the ratio of the length of the thick plate 42 to the total length La of the impact member 34 should be 50 to 80%, more preferably 60 to 80%, and further preferably 70 to 80%.

It is possible to reduce the ratio of the length of the chain 40 to the length of the impact member 34 to a value lower than the conventional ratio (for example, 33 to 40%) by setting the ratio of the length of the thick plate 42 to the total length of the impact member 34 as described above. Therefore, the possibility that raw material soil comes into contact with the chain 40 can be reduced. As a result, it is possible to prevent the chain 40 from being damaged and reduce the frequency of replacement of the chain 40. Note that when the chain 40 and the thick plate 42 are integrally formed, the frequency of replacement of the impact member 34 can be reduced.

Furthermore, as a result of setting the ratio as described above, weight can be reduced compared with the case where the ratio of the length of the thick plate 42 to the total length is higher (for example, higher than 80%). Thus, energy (electric power and the like) required for using a rotary crushing apparatus 100 can be reduced, so that a reduction in cost can be achieved.

In addition, as a result of setting the ratio as described above, a sufficient rate of the chain 40 is ensured as compared with the case where the ratio of the length of the thick plate 42 to the total length is higher (for example, higher than 80%). Thus, the thick plate 42, which is not deformable, can be easily replaced, so that maintainability can be improved.

The following is a list of reference numbers used in the drawings and this description.

| 10a | top plate |
|---|---|
| 12 | stationary drum |
| 14 | rotating drum |
| 20 | inlet member |
| 22 | scraping rod |
| 30 | rotating shaft |
| 34 | impactor (impact applying member) |
| 36a, 36b | ball bearing (bearing member) |
| 100 | rotary crushing apparatus |
| 122 | conveyor belt |

1. A rotary crushing apparatus comprising:
an impactor that is connected to a vertically-extending rotating shaft and crushes a processing object by means of rotation of the rotating shaft about the vertical direction; and
a feeder that feeds the processing object along the vertical direction to a position between a position of a center of gravity of the impactor and a tip side of the impactor in such a way that an axis direction of conveyance of the processing object is substantially identical to a movement direction of the impactor when the impactor comes into contact with the processing object.

2. The rotary crushing apparatus according to claim 1, wherein
the feeder is positioned so as to feed the processing object to a position between the position of the center of gravity of the impactor and the tip side of the impactor, the position being obtained based on a moment of inertia of the impactor and a mass of the impactor.

3. The rotary crushing apparatus according to claim 1, wherein
the feeder feeds the processing object to the impactor in such a way as to put the processing object in a position of a center of percussion of the impactor.

4. The rotary crushing apparatus according to claim 3, wherein
the feeder feeds the impactor with the processing object having a shape symmetrical about the position of the center of percussion.

5. The rotary crushing apparatus according to claim 1, wherein
the rotating shaft is cantilevered by a bearing member.

6. The rotary crushing apparatus according to claim 1, wherein
a length of the rotating shaft is set in such a way that when the impactor is centrifugally rotated, an amount of deflection of the rotating shaft is 1/800 to 1/3,000 of the length of the rotating shaft.

7. A rotary crushing method comprising:
rotating an impactor by means of rotation of a vertically-extending rotating shaft about the vertical direction in a horizontal plane, the impactor being capable of crushing a processing object; and
feeding the processing object along the vertical direction to a position between a position of a center of gravity of the impactor and a tip side of the impactor in such a way that an axis direction of conveyance of the processing object is substantially identical to a movement direction of the impactor when the impactor comes into contact with the processing object.

8. The rotary crushing method according to claim 7, wherein
feeding the processing object includes feeding the processing object to a position between the position of the center of gravity of the impactor and the tip side of the impactor, the position being obtained based on a moment of inertia of the impactor and a mass of the impactor.

9. The rotary crushing method according to claim 7, wherein
feeding the processing object includes feeding the processing object to the impactor in such a way as to put the processing object in a position of a center of percussion of the impactor.

10. The rotary crushing method according to claim 9, wherein
feeding the processing object includes feeding the impactor with the processing object having a shape symmetrical about the position of the center of percussion.

11. A rotary crushing apparatus comprising:
an impactor that is connected to a rotating shaft and crushes a processing object by means of rotation of the rotating shaft; and
a feeder that feeds the processing object to the impactor, the feeder being positioned at an inlet for the processing object in such a way that a center of a range into which the processing object is fed passes through between a position of a center of gravity of the impactor and a tip located on a side opposite to the rotating shaft.

12. The rotary crushing apparatus according to claim 1, wherein
the impactor includes a chain and a collision member, the chain being connected to the rotating shaft, and the collision member being provided at a tip of the chain and configured to collide with the processing object and crush the processing object by means of rotation of the rotating shaft; and
a length of the collision member is 50% to 80% of a total length of the impactor.

13. The rotary crushing apparatus according to claim 12, wherein
the length of the collision member is 60% to 80% of the total length of the impactor.

14. The rotary crushing apparatus according to claim 12, wherein
the length of the collision member is 70% to 80% of the total length of the impactor.

15. The rotary crushing method according to claim 8, wherein
feeding the processing object includes feeding the processing object to the impactor in such a way as to put the processing object in a position of a center of percussion of the impactor.

16. The rotary crushing method according to claim 15, wherein
feeding the processing object includes feeding the impactor with the processing object having a shape symmetrical about the position of the center of percussion.

17. The rotary crushing apparatus according to claim 2, wherein
the feeder feeds the processing object to the impactor in such a way as to put the processing object in a position of a center of percussion of the impactor.

18. The rotary crushing apparatus according to claim 17, wherein
the feeder feeds the impactor with the processing object having a shape symmetrical about the position of the center of percussion.

19. The rotary crushing apparatus according to claim 2, wherein
the rotating shaft is cantilevered by a bearing member.

20. The rotary crushing apparatus according to claim 3, wherein
the rotating shaft is cantilevered by a bearing member.
